(19) United States
(12) Patent Application Publication
(10) Pub. No.: US 2013/0108908 A1
(43) Pub. Date: May 2, 2013

(54) POWER SUPPLY APPARATUS HAVING PLURALITY OF BATTERY CELLS

(71) Applicant: Sanyo Electric Co., Ltd., Moriguchi City (JP)

(72) Inventors: Tetsuji Omura, Kasai City (JP); Takashi Seto, Kakogawa City (JP); Mitsutoshi Tajima, Kasai City (JP)

(73) Assignee: Sanyo Electric Co., Ltd., Moriguchi City (JP)

(21) Appl. No.: 13/658,289

(22) Filed: Oct. 23, 2012

(30) Foreign Application Priority Data
Oct. 28, 2011 (JP) 2011-237006

(51) Int. Cl. H01M 2/10

(52) U.S. Cl. 429/94; 429/156

(57) ABSTRACT

A power supply apparatus includes: a plurality of battery cells each having a flat rectangular parallelepiped outer can, the battery cells provided so that wide surfaces of the outer cans are opposed to each other; a separator provided between the battery cells; and a fastener fastening the battery cells and the separator with the battery cells under application of pressure. The wide surface of the outer can includes a circumference portion at a circumference of the wide surface and a central portion in a center of the wide surface. The separator includes an insulating portion insulating the adjacent battery cells and a pressing portion formed at a position corresponding to the central portion of the wide surface for pressing the central portion.

### BACKGROUND OF THE INVENTION

1. Field of the Invention

The present invention relates to a power supply apparatus having a plurality of battery cells.

2. Description of the Related Art

Power supply apparatuses used for hybrid automobiles, electric automobiles, large-sized electrical storage apparatuses, or the like are required to have a high-voltage output and a high-current capacity. Such power supply apparatuses include a power supply apparatus formed by laminating a plurality of battery cells. By connecting the battery cells in series, an output voltage of the power supply apparatus can be increased, whereas by connecting the battery cells in parallel, a current capacity of the power supply apparatus can be increased. A secondary battery cell is used as the battery cell of the power supply apparatus in order to allow a repetition of charging and discharging.

Since battery cells expand due to a repetition of charging and discharging, secondary battery cells deteriorate in performance (input-output characteristics) in accordance with the expansion. Therefore, the power supply apparatus formed by laminating a plurality of battery cells is provided in which the apparatus includes a faster for preventing expansion of the battery cells by fastening the battery cells under application of pressure, thereby suppressing the deterioration in battery performance in accordance with the expansion.

As this type of power supply apparatus, for example, known is a power supply apparatus including: a battery block formed by alternately laminating rectangular battery cells, as a battery cell, each having a rectangular parallelepiped outer can, and separators holding the rectangular battery cells; a pair of end plates provided at both ends of the battery block; and a binding bar fixed to the end plates for fastening the laminated rectangular battery cells in a direction of the lamination under application of pressure (Japanese Patent Laid-Open No. 2011-34775). According to the configuration, by fastening the battery block via the binding bar, the outer can of each rectangular battery cell is pressed by the adjacent separator, leading to suppression of expansion of the outer can. Specifically, a size of the rectangular battery cell is restricted by the binding bar fixed to the end plates. The expansion of the outer can is therefore prevented by the separator pressing a wide surface of the outer can even if an internal pressure of the outer can increases due to the repetition of charging and discharging.

The deterioration in battery performance is also influenced by a life of the battery cell (increase of an internal resistance due to aging, or the like). Specifically, a life of the battery cell is reduced due to usage under a high temperature. As for the power supply apparatus disclosed in JP 2011-34775-A, in addition to the above configuration, the outer can is made of metal for increasing heat dissipation performance of the battery cell, as well as each of the battery cells can be cooled via a cooling plate abutting on a lower part of the battery block.

In the case of using the outer can made of metal, adjacent battery cells need to be insulated each other because a potential difference between the outer cans of the adjacent battery cells is caused. The adjacent battery cells also need to be insulated each other in a power supply apparatus having a cooling mechanism such as a cooling plate. This is because condensed water may adhere to the outer can or the like due to a difference in temperature with surroundings.

In the power supply apparatus disclosed in JP 2011-34775-A, adjacent battery cells are insulated by providing a separator having an insulation property between the adjacent battery cells.

In the power supply apparatus disclosed in JP 2011-34775-A, the separator insulates the adjacent battery cells and prevents the expansion of the outer can by pressing the outer can of the battery cell via the binding bar.

In the configuration disclosed in JP 2011-34775-A, the separator uniformly presses the wide surface of the outer can. Sufficient study, however, has not been made on an optimal shape of the separator for efficiently suppressing the deterioration in battery performance of the rectangular battery cell due to the expansion. A power supply apparatus for efficiently preventing the expansion of the rectangular battery cell has therefore been desired.

The present invention has been made for solving such a problem. An object of the present invention is to provide a power supply apparatus formed by laminating a plurality of battery cells and capable of suppressing deterioration in battery performance.

### SUMMARY OF THE INVENTION

A power supply apparatus according to the present invention includes: a plurality of battery cells each having a flat rectangular parallelepiped outer can, the battery cells provided so that wide surfaces of the outer cans are opposed to each other; a separator provided between the battery cells; and a fastener fastening the battery cells and the separator with the battery cells under application of pressure, wherein the wide surface of the outer can includes a circumference portion at a circumference of the wide surface and a central portion in a center of the wide surface, and wherein the separator includes an insulating portion insulating the adjacent battery cells and a pressing portion formed at a position corresponding to the central portion of the wide surface for pressing the central portion.

It is preferred that the outer can is a closed-end case for housing whose top surface is opened, the battery cell includes an electrode assembly provided in the outer can, a sealing body sealing an opening of the outer can, and output terminals fixed to the sealing body and electrically connected to the electrode assembly, and the separator is provided so as to have space between the circumference portion in the vicinity of the sealing body and the insulating portion.

It is preferred that the insulating portion is provided so as to protrude upward over an end surface of the sealing body of the outer can.

It is preferred that the battery cell includes a current blocking mechanism electrically blocking the output terminal and the electrode assembly when an internal pressure of the outer can increases, the current blocking mechanism provided in the vicinity of the sealing body.

It is preferred that the pressing portion includes a peak portion in a center of the pressing portion and a circumference portion at a circumference of the peak portion, and the pressing portion further includes a first inclined plane formed from the peak portion to the circumference portion on un upper side and a second inclined plane formed from the peak portion to the circumference portion on a lower side.

It is preferred that the first inclined plane has a gentler gradient than does the second inclined plane.

It is preferred that the electrode assembly is formed by winding a laminate including a positive electrode and an negative electrode to obtain a wound body, the wound body provided in the outer can with an axial direction of the wound body parallel to the wide surface and oriented toward a horizontal direction of the outer can, the pressing portion includes a third inclined plane and a fourth inclined plane formed from the peak portion to the circumference portion provided on both sides, and the pressing portion is further formed so that gradients of the third inclined plane and the fourth inclined plane become equal.

It is preferred that the current blocking mechanism is provided on one of the output terminals, the pressing portion includes a third inclined plane and a fourth inclined plane formed from the peak portion to the circumference portion provided on both sides, the third inclined plane is formed in the vicinity of the current blocking mechanism, and the pressing portion is further formed so that the third inclined plane has a steeper gradient than does the fourth inclined plane.

According to a configuration of claim 1, the adjacent battery cells can be insulated and the central portion of the outer can more likely to expand can be pressed. The expansion of the battery cell can therefore be efficiently suppressed, for example.

According to a configuration of claim 2, providing the space can perform insulation without pressing the circumference portion in the vicinity of the sealing body. Damage of a welded part between the sealing body and the outer can therefore be prevented, for example.

According to a configuration of claim 3, the insulating portion can be provided between the output terminals of the adjacent battery cells. A short circuit due to water condensation or the like can therefore be prevented, for example.

According to a configuration of claim 4, the current blocking mechanism operated depending on the internal pressure of the outer can is provided in the vicinity of the sealing body where a load is hard to be applied by the pressing portion. A malfunction of the current blocking mechanism can therefore be prevented, for example.

According to a configuration of claim 5, the inclined plane is formed from the peak portion to the circumference portion in the pressing portion. A contact area between the pressing portion and the wide surface of the outer can can therefore be gently changed depending on a fastening force by the fastener, for example.

According to a configuration of claim 6, the wide surface on a bottom side can be mainly pressed. A load applied to the sealing body or the like can therefore be reduced, for example.

According to a configuration of claim 7, the wide surface can be uniformly pressed in the axial direction of the electrode assembly, for example.

According to a configuration of claim 8, the third inclined plane close to the current blocking mechanism has a steeper gradient than does the fourth inclined plane. A load applied to the current blocking mechanism can therefore be reduced and the malfunction of the current blocking mechanism can be prevented, for example.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view of a power supply apparatus 1 according to an embodiment of the present invention;

FIG. 2 is a perspective view of a rectangular battery cell 2 according to the embodiment of the present invention;

FIG. 3 is a vertical longitudinal-sectional view of the rectangular battery cell 2;

FIG. 4 is a vertical cross-sectional view of the rectangular battery cell 2;

FIG. 5 is a cross-sectional view illustrating a configuration of a current blocking mechanism 7 according to the embodiment of the present invention;

FIG. 6 is a cross-sectional view illustrating a diaphragm at the time of operating the current blocking mechanism 7;

FIG. 7 is a cross-sectional view illustrating a shape of a separator 3A of the present invention;

FIG. 8 is a top view illustrating the shape of the separator 3A;

FIG. 9 is a cross-sectional view illustrating a shape of a separator 3B of the present invention;

FIG. 10 is a cross-sectional view illustrating a shape of a separator 3C of the present invention;

FIG. 11 is a cross-sectional view illustrating a shape of a separator 3D of the present invention;

FIG. 12 is a top view illustrating a shape of a separator 3E of the present invention;

FIG. 13 is a top view illustrating a shape of a separator 3F of the present invention;

FIG. 14 is a cross-sectional view illustrating the separator 3 (3A) having an insulating portion and a pressing portion of the present invention integrally molded;

FIG. 15 is a graph showing a relationship between a pressing force and a cell width of the rectangular battery cell 2 when a plate-like separator is used for pressing;

FIG. 16 is a graph showing a relationship between a pressing force and a cell width of the rectangular battery cell 2 when the separator according to the embodiment of the present invention is used for pressing; and

FIG. 17 is a cross-sectional view illustrating a shape of a separator according to another embodiment.

### DETAILED DESCRIPTION OF THE EMBODIMENT(S)

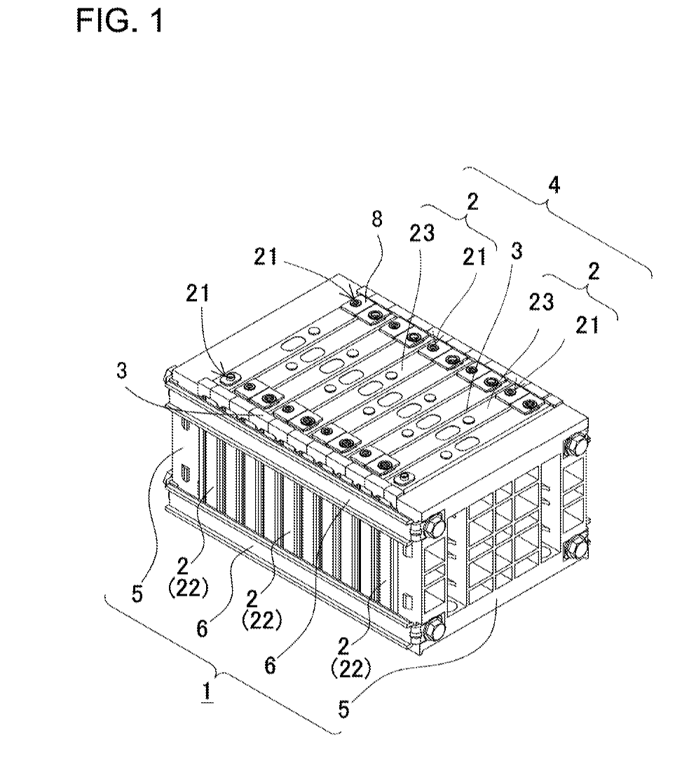

An embodiment of the present invention will be described in detail below with reference to FIGS. 1 to 14.

FIG. 1 is a perspective view of a power supply apparatus 1 according to the embodiment of the present invention. As illustrated in FIG. 1, the power supply apparatus 1 includes a battery block 4 formed by alternately laminating rectangular battery cells 2 and separators 3 having an insulating property, end plates 5 provided at both ends of the battery block 4, and binding bars 6 each being fixed to the end plates 5 as a fastener for fastening the battery block 4 in a direction of the lamination under application of pressure.

The rectangular battery cells 2 of the battery block 4 are laminated so that output terminals 21 form a line on a top surface of the battery block 4. The rectangular battery cells 2 adjacent to each other are connected via a bus bar 8. The rectangular battery cells 2 are connected in series to increase an output voltage of the power supply apparatus 1. An outer shape of the end plates 5 provided at the both ends of the battery block 4 is a rectangular parallelepiped substantially similar to an outer shape of the rectangular battery cell 2. The end plate 5 is made of metal having relatively high strength such as aluminum and aluminum alloy, rigid plastic, or the like. Threaded holes for screwing and fixing a pair of binding bars 6 provided in parallel with each other in a vertical direction are formed at four corners of each of the end plates 5. This allows the binding bars 6 to be fixed to the end plates 5.

Although the rectangular battery cells 2 are connected in series in the above embodiment, the rectangular battery cells 2 may be connected in parallel. Connecting the rectangular battery cells 2 in parallel can increase a current capacity of the power supply apparatus 1. The battery block 4 may be formed by combining parallel connection and series connection depending on an intended output voltage or current capacity.

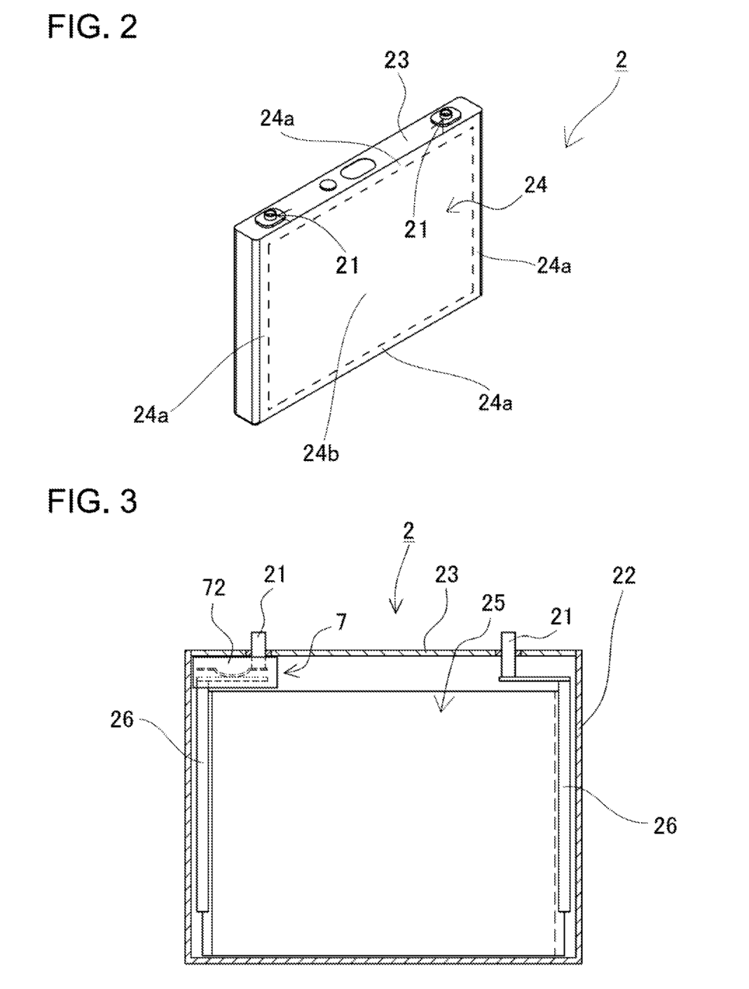

FIGS. 2 to 4 show a configuration of the rectangular battery cell 2. As illustrated in FIGS. 2 to 4, the rectangular battery cell 2 is a battery cell having an outer can 22 of a flat rectangular parallelepiped with a top surface opened, a sealing body 23 sealing an opening of the outer can 22, and output terminals 21 fixed to the sealing body 23. The rectangular battery cell 2 is, for example, a secondary battery cell such as a lithium ion battery cell or a nickel-metal hydride battery cell. The outer can 22 is made of metal having excellent thermal conductivity, thereby improving a cooling property of the rectangular battery cell 2. Metal having excellent thermal conductivity includes, for example, aluminum and aluminum alloy. The outer can 22 has wide surfaces 24 opposed to the separator 3. The binding bar 6 fastens the battery block 4, so that the wide surfaces 24 are pressed by the separator 3. The wide surface 24 of the outer can 22 includes a circumference portion 24a at a circumference of the wide surface 24 and a central portion 24b in a center thereof. When an internal pressure of the outer can 22 increases due to a repetition of charging and discharging, the central portion 24b of the outer can 22 particularly expands in the rectangular battery cell 2 with the configuration.

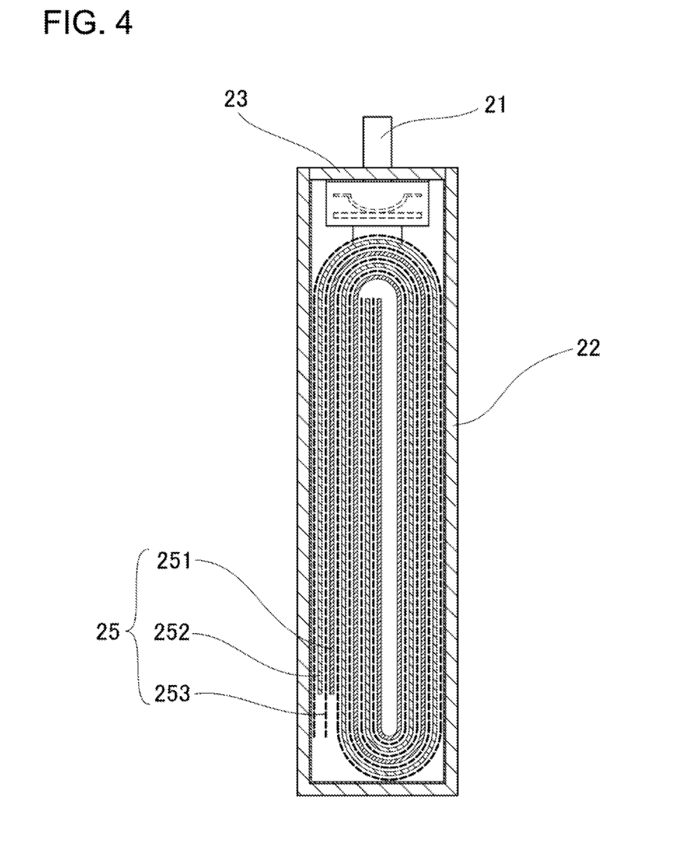

As illustrated in the cross-sectional views in FIGS. 3 and 4, the outer can 22 encloses: an electrode assembly 25 formed by winding a laminate including a positive electrode 251, an negative electrode 252 and an insulating sheet 253 lying therebetween; and an electrolytic solution (not shown). One of the two output terminals 21 is electrically connected to the positive electrode 251 and the other of the two output terminals 21 is electrically connected to the negative electrode 252 via respective electrode collectors 26. A current blocking mechanism 7 is provided between the positive electrode 251 and the output terminal 21 connected to the positive electrode 251. The current blocking mechanism 7 blocks a current when an internal pressure of the battery cell, that is, the internal pressure of the outer can 22 becomes higher than a set pressure.

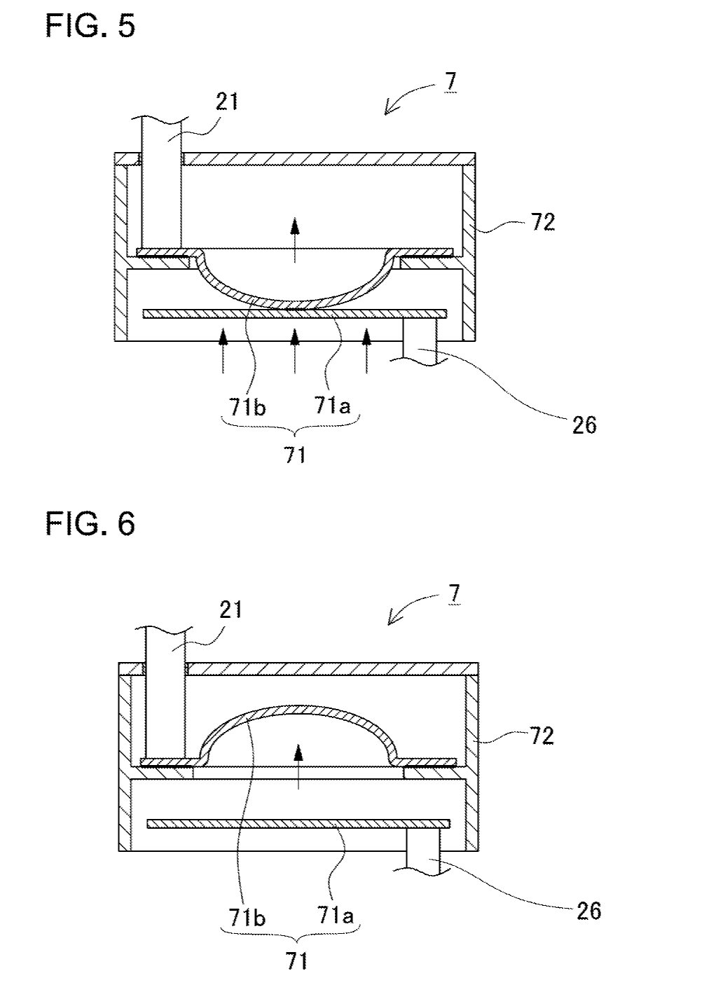

FIGS. 5 and 6 are cross sectional views illustrating a specific configuration of the current blocking mechanism 7. The current blocking mechanism 7 has a conducting portion 71 electrically connecting the output terminal 21 and the positive electrode 251, and is provided in the vicinity of the sealing body 23. The conducting portion 71 includes a metal part 71a for connection electrically connected to the positive electrode 251, and a diaphragm 71b deformed according to the internal pressure of the outer can 22 and made of metal. As for the diaphragm 71b, an outer circumference thereof abuts on a bottom end of the output terminal 21 fixed to the sealing body 23. By welding the abutment part, the output terminal 21 and the diaphragm 71b are electrically connected. The diaphragm 71b and the metal part 71a for connection are housed in an inner case 72 made of an insulating material such as plastic.

A topside of the diaphragm 71b is airtightly sealed in the inner case 72. The internal pressure of the outer can 22 does not act upon the topside of the diaphragm 71b by airtightly sealing the topside of the diaphragm 71b. The internal pressure of the outer can 22 acts upon an underside of the diaphragm 71b, so that a force pushing up the diaphragm 71b acts because of the internal pressure. The force pushing up the diaphragm 71b becomes larger in proportion to the internal pressure of the outer can 22. With the sufficiently small internal pressure of the outer can 22, the force pushing up the diaphragm 71b is also small, and therefore, deformation of the diaphragm 71b is prevented by sealed air on the topside of the diaphragm 71b. When increase of the internal pressure of the outer can 22 causes the force pushing up the diaphragm 71b to exceed a certain constant value, the deformation of the diaphragm 71b cannot be prevented, resulting in the deformation as illustrated in FIG. 6. The diaphragm 71b in FIG. 6 is apart from the metal part 71a for connection, causing the output terminal 21 and the positive electrode 251 to be electrically blocked. The internal pressure causing the diaphragm 71b to be deformed can be set according to a material thickness or a shape of the diaphragm 71b. The deformed diaphragm 71b, as illustrated in FIG. 6, is maintained in the shape unless an external force acts. Therefore, once the current blocking mechanism 7 operates, the output terminal 21 and the positive electrode 251 are kept blocked electrically thereafter.

The configuration allows the rectangular battery cell 2 to be electrically blocked from a load to which the power supply apparatus 1 is connected such as a motor for vehicle when the internal pressure of the outer can 22 extraordinarily increases, for example. Although the current blocking mechanism 7 is provided on a side of the positive electrode 251 in the above embodiment, the current blocking mechanism 7 may be provided on a side of the negative electrode 252.

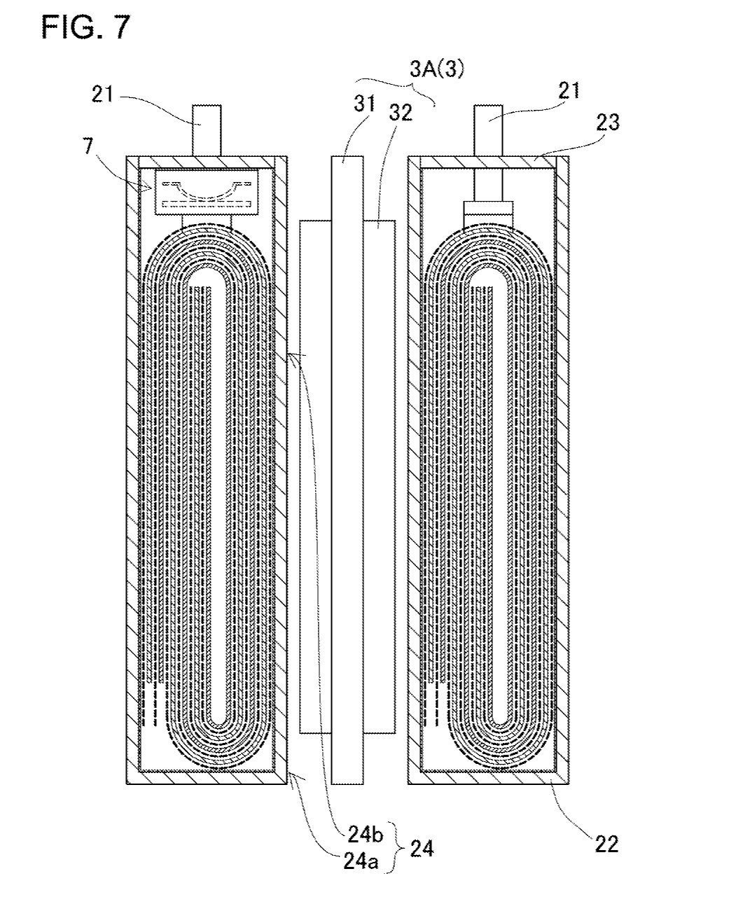

FIGS. 7 to 13 are cross-sectional views illustrating a shape of the separator 3. As illustrated in FIG. 7, the separator 3 is provided between the rectangular battery cells 2 adjacent to each other. The separator 3 has an insulating portion 31 for insulating the adjacent rectangular battery cells 2, and pressing portions 32 each of which is provided at a position opposed to the central portion 24b of the wide surface 24 of the outer can 22. Specifically, the pressing portion 32 is preferably formed at a position corresponding to the electrode assembly 25 enclosed in the outer can 22 so as to press a part of the wide surface 24 provided below the current blocking mechanism 7.

When the end plate 5 is made of metal, the separator 3 is provided between the end plate 5 and the rectangular battery cell 2. The separator 3 provided at an end of the battery block 4 has only one surface opposed to the rectangular battery cell 2, and the pressing portion 32 is also formed on the surface opposed to the rectangular battery cell 2. The separator 3 at the end may be formed into such a shape as to fit the separator 3 into the end plate 5 for holding the end plate 5. Forming into such a shape can prevent displacement of the end plate 5 when the battery block 4 is fastened by the binding bars 6.

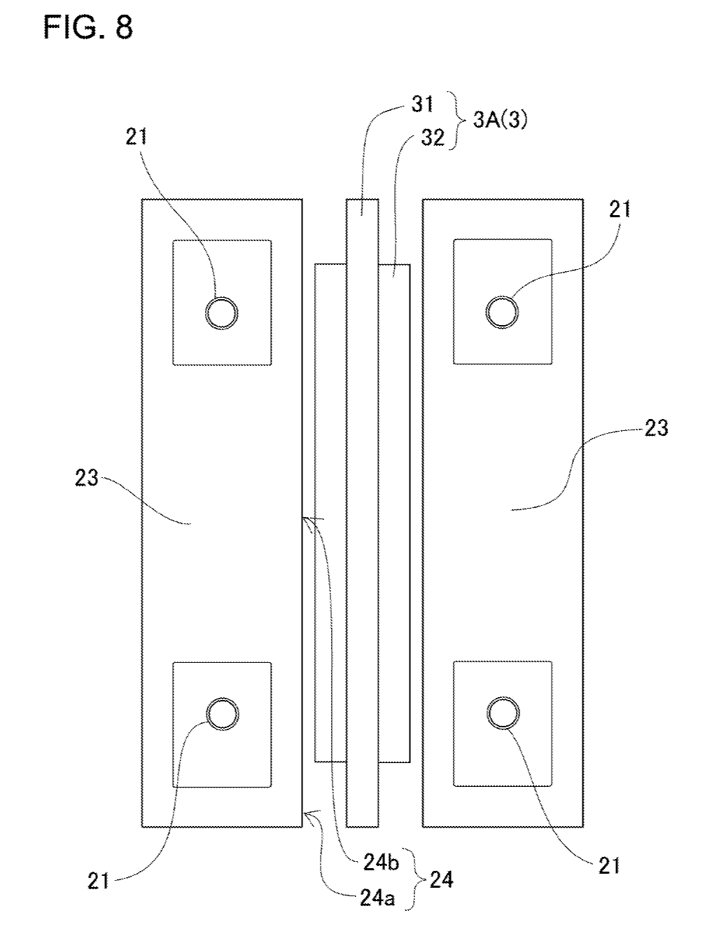

As for a separator 3 (3A) illustrated in FIG. 7, the pressing portion 32 is formed into such a shape as to protrude toward the wide surface 24 of the outer can 22 compared with the insulating portion 31. In the vicinity of the circumference portion 24a of the outer can 22, as illustrated in FIGS. 7 and 8, a step is provided with respect to the pressing portion 32 so as to provide space between the insulating portion 31 and the circumference portion 24a of the outer can 22. The space is not necessarily provided between the insulating portion 31 and the outer can 22. It is however preferred that the space is at least provided between the circumference portion 24a in the vicinity of the sealing body 23 and the insulating portion 31 of the separator 3A.

As described above, in the outer can 22 of the rectangular battery cell 2, the central portion 24b of the wide surface 24 particularly expands, while the circumference portion 24a of the wide surface 24 does not very expand. In such a configuration, if the circumference portion 24a of the outer can 22 is pressed, expansion of the outer can 22 cannot be prevented efficiently. This is because a part hardly expanding is pressed. Additionally, when an excessive force is applied to the circumference portion 24a of the outer can 22, particularly the circumference portion 24a in the vicinity of the sealing body 23, a welded part between the sealing body 23 and the outer can 22 may be cracked, or the weld may peel off.

According to the above configuration, the pressing portion 32 of the separator 3A mainly presses the central part of the wide surface 24 of the outer can 22 when the binding bars 6 fasten the battery block 4. The central portion 24b of the wide surface 24 with a large change in expansion can therefore be pressed, allowing the expansion of the outer can 22 to be efficiently suppressed. Additionally, in the configuration, a load is hard to be applied to the sealing body 23 and the like. The welded part between the sealing body 23 and the outer can 22 can therefore be prevented from being cracked and the weld can be prevented from peeling off, thereby being able to provide a safer power supply apparatus.

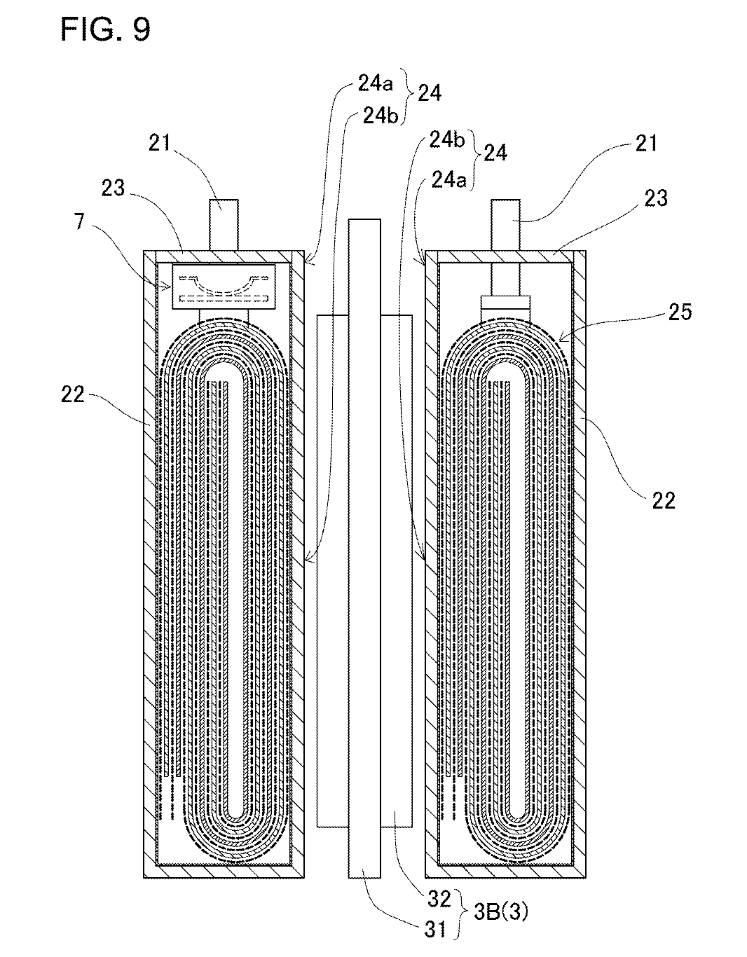

As for a separator 3 (3B) illustrated in FIG. 9, the insulating portion 31 is provided so as to protrude upward over an end of the outer can 22 in the vicinity of the sealing body 23. As described above, condensed water may adhere to the surface of the outer can 22 due to a difference in temperature with surroundings in the case of the power supply apparatus 1 with a cooling mechanism. In particular, when the outer can 22 is made of metal, the adhesion of the condensed water becomes significant. As for the separator 3B illustrated in FIG. 9, the insulating portion 31 is provided between the output terminals 21 of the adjacent rectangular battery cells 2, and therefore, the adjacent rectangular battery cells 2 do not come into contact with each other via condensed water, for example, even if the condensed water adheres to the outer can 22. This enables prevention of a short circuit of the adjacent rectangular battery cells 2. Accordingly, the power supply apparatus 1 having the separator 3B illustrated in FIG. 9 employs a shape of the separator for efficiently preventing the expansion of the rectangular battery cell 2, and further, the short circuit due to the condensed water can be prevented by the insulating portion 31.

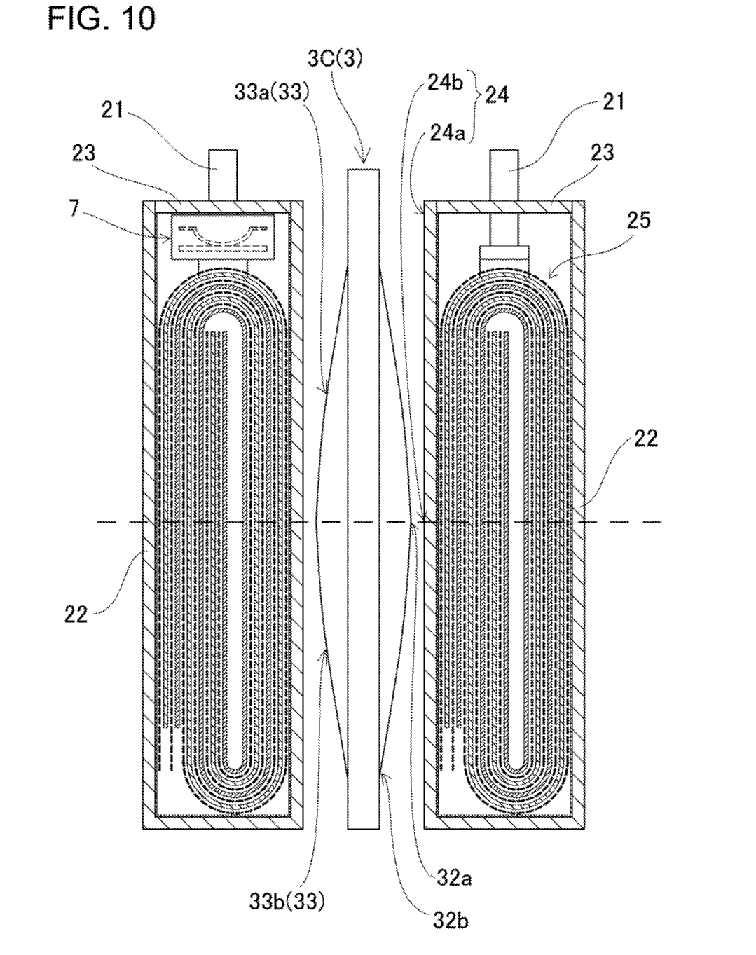

FIGS. 10 to 13 illustrate a shape of the pressing portion 32 for more efficiently pressing the wide surface 24 of the outer can 22. In the separators 3 illustrated in FIGS. 10 to 13, the pressing portion 32 has a peak portion 32a in a center thereof and a circumference portion 32b at a circumference thereof. A gently inclined plane 33 is formed from the peak portion 32a to the circumference portion 32b. According to the configuration, a contact area between the pressing portion 32 of the separator 3 and the wide surface 24 of the outer can 22 can be changed depending on a fastening force. Specifically, when the outer can 22 hardly expands, the peak portion 32a of the pressing portion 32 of the separator 3 mainly comes into contact with the wide surface 24. When the outer can 22 significantly expands, the peak portion 32a and the circumference portion 32b of the pressing portion 32 of the separator 3 press the wide surface 24. At this time, the contact area between the pressing portion 32 and the wide surface 24 of the outer can 22 changes depending on a gradient of the inclined plane 33. For example, when the pressing portion 32 is formed with a gentle gradient of the inclined plane 33, the contact area abruptly changes with respect to a change of the fastening force. On the other hand, when the inclined plane 33 is formed so as to have a steep gradient, the contact area between the pressing portion 32 and the wide surface 24 gently changes with respect to the change of the fastening force.

In a separator 3 (3C) in FIG. 10, the pressing portion 32 has a first inclined plane 33a formed from the peak portion 32a to the circumference portion 32b on a side of the output terminal 21, and a second inclined plane 33b formed from the peak portion 32a to the circumference portion 32b on a bottom side. According to the configuration, the contact area between the pressing portion 32 and the wide surface 24 can be changed depending on the gradient of the inclined plane 33, as described above. This therefore enables reduction of a load applied to the circumference portion 32b on the side of the output terminal 21 and the circumference portion 32b on the bottom side.

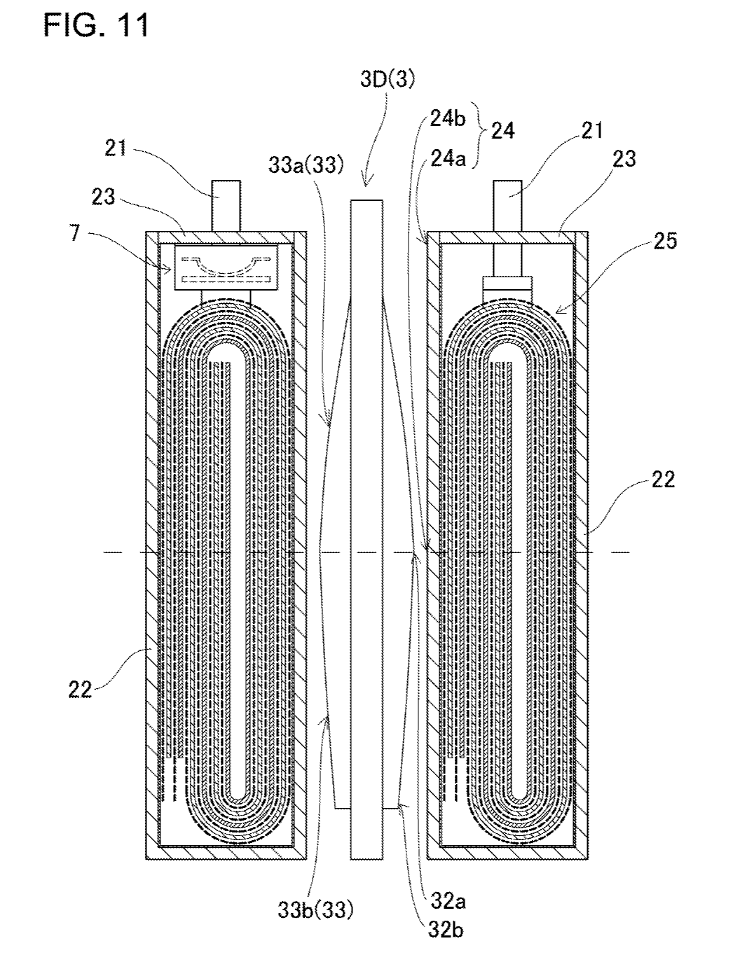

As illustrated in FIG. 11, the inclined planes 33a and 33b may be formed so as to have different gradients. A separator 3 (3D) illustrated in FIG. 11 is formed so that inclination of the second inclined plane 33b is gentler than that of the first inclined plane 33a. Therefore, increase/decrease of the contact area changes more on the bottom side. In other words, the separator 3D illustrated in FIG. 11 mainly presses the bottom side of the wide surface 24 of the outer can 22. The configuration can reduce a load applied to the sealing body 23 on the side of the output terminal 21 of the outer can 22.

Since the current blocking mechanism 7 is provided in the vicinity of the sealing body 23 in the above embodiment, a load applied to the current blocking mechanism 7 can also be reduced. In particular, the current blocking mechanism 7 described in the above embodiment may have the diaphragm 71b deformed when an external force (such as a pressing force of the pressing portion pressing the outer can) is applied to the diaphragm 71b. This is because the current blocking mechanism 7 blocks the electrical connection between the output terminal 21 and the electrode assembly 25 by deforming the diaphragm 71b depending on the internal pressure of the outer can 22. Specifically, even if the internal pressure of the outer can 22 is not very high, the diaphragm 71b may be deformed to block a current, or the external force applied to the current blocking mechanism 7 with the electrical connection between the output terminal 21 and the electrode assembly 25 being blocked may deform the diaphragm 71b, causing the output terminal 21 and the electrode assembly 25 to be connected again. Since the configuration of the separator 3D illustrated in FIG. 11 can reduce the load applied to the current blocking mechanism 7, a malfunction of the current blocking mechanism 7 may be prevented.

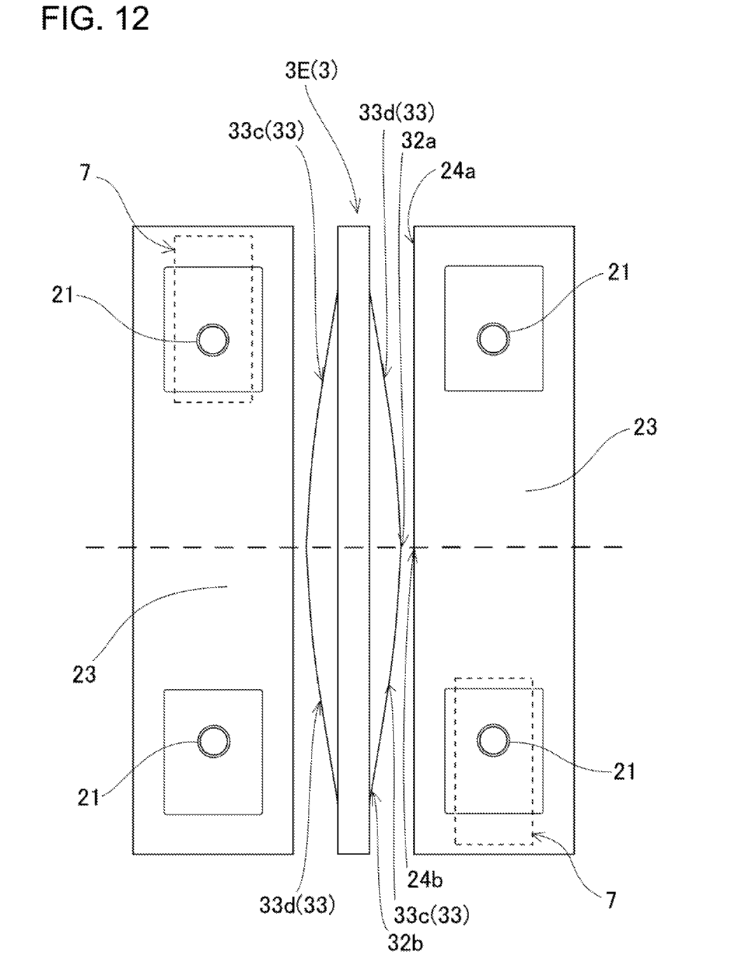

As for a separator 3 (3E) illustrated in FIG. 12, a third inclined plane 33c and a fourth inclined plane 33d are formed from the peak portion 32a to the circumference portion 32b on both of right and left sides. An inclined plane in the vicinity of the current blocking mechanism 7 refers to the third inclined plane 33c. The separator 3E illustrated in FIG. 12 is formed so that the third inclined plane 33c and the fourth inclined plane 33d have the same gradient. Since the separator 3E is symmetrically formed in a horizontal direction, the wide surface 24 of the outer can 22 can be uniformly pressed in the horizontal direction. As illustrated in FIG. 4 and the like, the electrode assembly 25 is enclosed in the outer can 22 so that an axial direction of the electrode assembly 25 is oriented toward the horizontal direction of the outer can 22. Therefore, by uniformly pressing the outer can 22, application of an uneven load to the electrode assembly 25 enclosed in the outer can 22 or the like can be prevented.

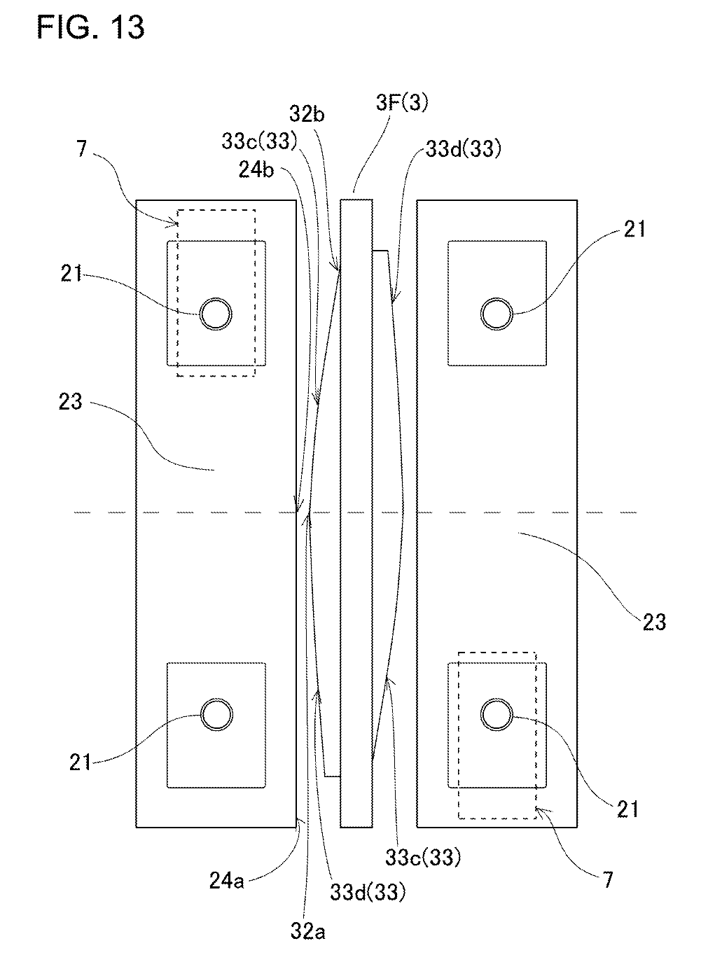

As for a separator 3 (3F) illustrated in FIG. 13, the third inclined plane 33c is formed so as to have a steeper gradient than does the fourth inclined plane 33d. As described above, a difference in the gradients of the inclined planes 33 allows the force pressing the wide surface 24 of the outer can 22 to be uneven. In the embodiment illustrated in FIG. 13, the third inclined plane 33c in the vicinity of the current blocking mechanism 7 is formed to have a steep gradient, thereby being able to further reduce the load applied to the current blocking mechanism 7.

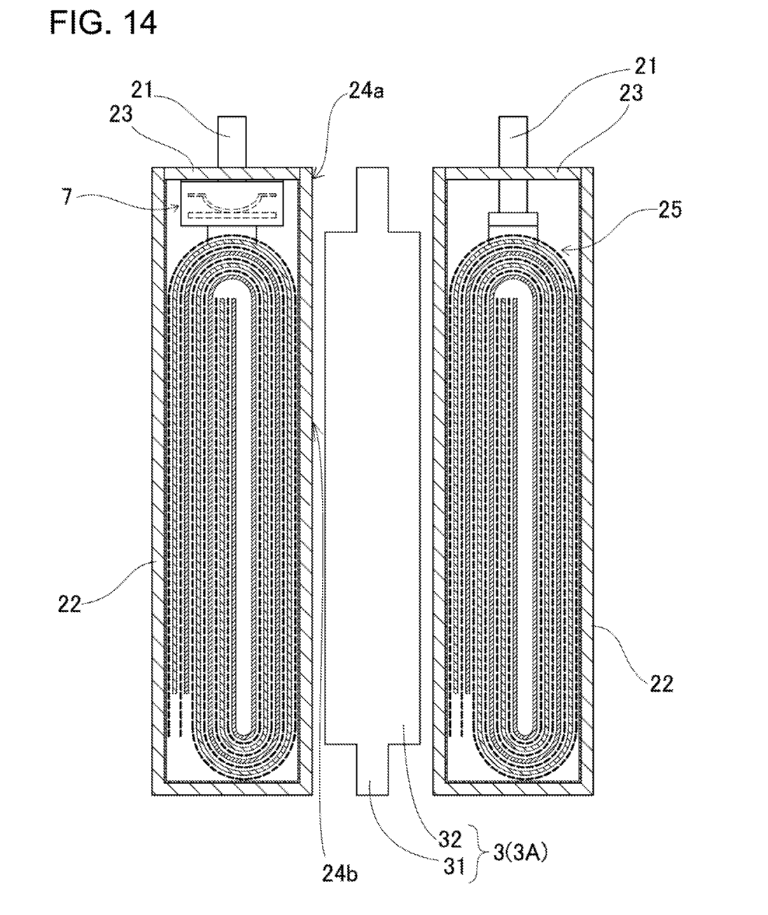

Although various shapes of the separator 3 are illustrated in FIGS. 10 to 13, various combinations can be made. In the embodiments illustrated in FIGS. 10 to 13, the insulating portion 31 and the pressing portions 32 of the separator 3 are different components, however, they may be integrally molded, as illustrated in FIG. 14. In the configuration, the insulating portion 31 and the pressing portions 32 are molded with an insulating material. A resin having relatively high strength and an insulating property is preferably used as the insulating material. When the insulating portion 31 and the pressing portions 32 are integrally molded, productivity of the separator 3 can be increased.

Further, in the above embodiment, inclination of the inclined plane 33 (33a, 33b, 33c and 33d) is not necessarily to have a gradient with a certain angle of inclination. The inclination of the inclined plane 33 may be formed so that the angle of inclination successively changes as getting away from the peak portion 32a, that is, a cross section of the pressing portion 32 has an arc shape.

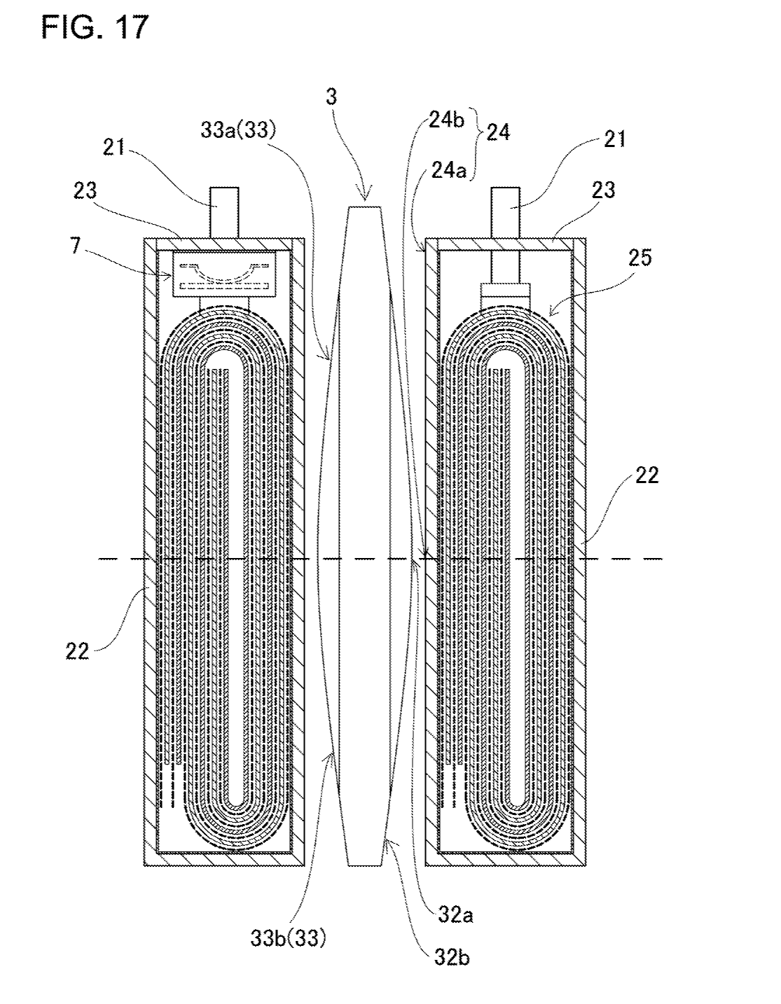

In the separators 3 illustrated in FIGS. 8 to 14, a part of the insulating portion 31 opposed to the circumference portion 24a is formed into a flat plane parallel to the wide surface 24. However, as illustrated in FIG. 17, the part of the insulating portion 31 opposed to the circumference portion 24a may be formed so as to be inclined along the inclined plane 33 of the pressing portion 32. In view of productivity and cost, the insulating portion 31 and the pressing portions 32 of the separator 3 may be integrally molded with using a resin having an insulating property, as illustrated in FIG. 14. In such a case, a complicated shape of the separator 3 requires a complicated mold for molding the separator 3, leading to a possibility of increasing the cost. According to the above configuration, the part of the insulating portion 31 opposed to the circumference portion 24a has the shape inclined along the inclined plane 33 of the pressing portion 32. The separator 3 therefore has a relatively simple shape, allowing the increase of the cost to be suppressed.

The shape of the separator 3 and a change in a fasting force of the binding bar 6 will now be described. Specifically, as for a relationship between a pressing force and a cell width when the separator presses the outer can 22, a comparison will be made between a typical plate-like separator and the separator 3D in the embodiment illustrated in FIG. 11.

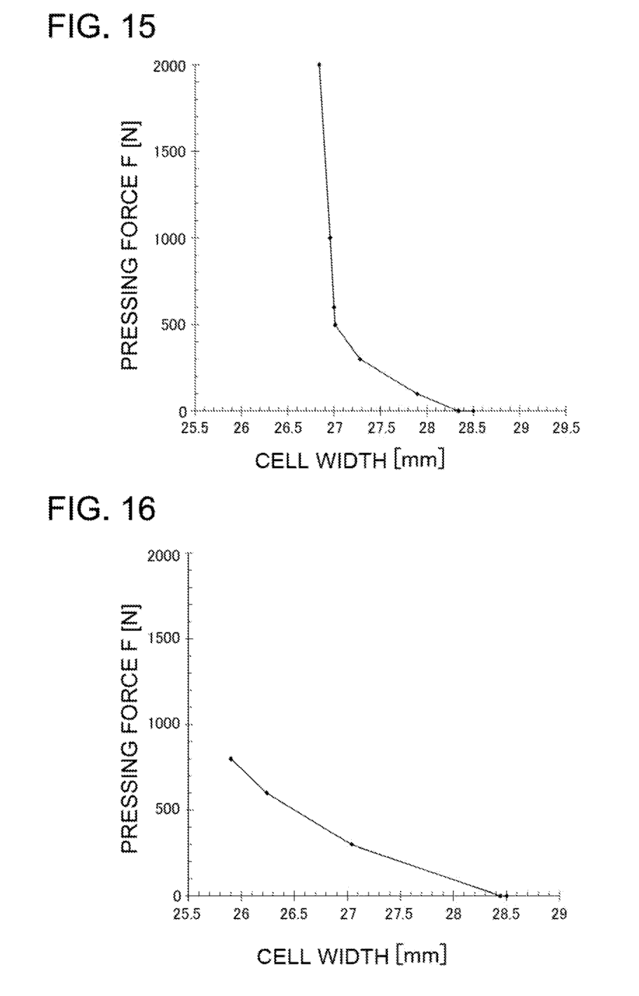

FIGS. 15 and 16 are graphs showing results of a simulation performed by an inventor of the present invention. A shape of the outer can 22 at the time of the expansion and strength with respect to the deformation of the outer can 22 are inputted to perform the simulation about deformation of a rigid body. Strictly, the shape of the outer can 22 is formed so that the wide surfaces 24 are inclined to have a wider space therebetween as getting close to the opening in the top surface sealed by the sealing body 23 in order to easily insert the electrode assembly 25 from the opening of the outer can 22. Values of the width of the outer can 22 are different between on a side of the sealing body and on the bottom side because of such a shape, however, a width of the central part of the outer can 22 is defined as a cell width in the following description.

FIG. 15 is a graph showing a relationship between a cell width and a pressing force F (the fastening force of the binding bar 6 in the above embodiment) when a typical plate-like separator is used for pressing the rectangular battery cell 2. Specifically, the graph shows a study having been made on the rectangular battery cell 2 whose outer can 22 with a width of 27 mm expands to about 28.5 mm. The graph is plotted with a vertical axis indicating a pressing force and a horizontal axis indicating a cell width. As is apparent from the FIG. 15, when the outer can 22 is pressed by the separator so that the cell width is reduced more than an original size (27 mm in FIG. 15), the pressing force to be required abruptly increases.

In the expanded outer can 22, the wide surface 24 of the outer can 22 mainly expands. When the expanded outer can 22 is pressed, only an expanded part of the outer can 22 is pressed by the separator. On the other hand, the outer can 22 of the rectangular battery cell 2 pressed up to the original size has the same outer shape or substantially the same outer shape as the outer can 22 that does not expand. Therefore, when the outer can 22 in such a state is further pressed to reduce the cell width, compared with the case of pressing only an expanded part of the outer can 22, a contact area between the separator and the outer can 22 changes, thereby abruptly increasing a pressing force required for reducing the outer can 22 in size.

Additionally, the shape of the outer can 22 is formed so that the wide surfaces 24 are inclined to have wider space therebetween on the side of the sealing body 23, as described above. When the outer can 22 of the rectangular battery cell 2 pressed up to the original size is further pressed by the plate-like separator, the plate-like separator abuts on the circumference portion 24a on the side of the sealing body 23 of the outer can 22. The abutment part in the vicinity of the circumference portion 24a of the outer can 22 corresponds to a part of the outer can 22 hard to be deformed. Therefore, when the size of the outer can 22 is reduced in a state of the separator and the circumference portion 24a of the outer can 22 being abutted each other, the pressing force to be required abruptly increases.

FIG. 16 is a graph showing a relationship between a cell width and a pressing force F when the separator 3D in the above embodiment is used for pressing the rectangular battery cell 2. Specifically, similarly to the FIG. 15, the graph shows a study having been made on the rectangular battery cell 2 whose outer can 22 with a width of 27 mm expands to about 28.5 mm. The graph is plotted with a vertical axis indicating a pressing force and a horizontal axis indicating a cell width. As shown in FIG. 16, when the separator 3D in the above embodiment presses the expanded outer can 22, a pressing force does not abruptly change even if the cell width is reduced more than 27 mm (original size). Results are different from those of FIG. 15 with using the typical separator. This is because forming the shape of separator into the shape of separator 3D allows the contact area between the outer can 22 and the separator 3D not to change much even if the cell width changes.

As described above, since the space is provided between the circumference portion 24a and the insulating portion 31, the separator 3 can be formed so as not to abut on the vicinity of the circumference portion 24a regardless of the cell width of the outer can 22. Additionally, by providing an inclined plane on the pressing portion 32, the contact area between the separator 3 and the wide surface 24 of the outer can 22 can gently change.

In the meantime, outer cans vary in size at the time of production. Such a dimensional error cannot be completely eliminated. When a dimensional error occurs in the outer can 22, a relationship between the cell width of the outer can 22 and the pressing force F corresponds to one obtained by laterally translating the graphs in FIGS. 15 and 16. For example, a dimensional error of the outer can 22 is on the order of 0.1 mm with respect to the outer can 22 with the cell width of 27 mm. When the rectangular battery cells 2 are not bound in the power supply apparatus 1 of the above embodiment, various problems arise such as falling off the laminated rectangular battery cell 2 or increase of a load applied to the bus bar 8. Therefore, the state of the rectangular battery cells 2 not being bound needs to be avoided in the power supply apparatus 1 of the above embodiment. The binding bar 6 needs to be formed so as to bind the rectangular battery cells 2 with a force slightly larger than an optimal value with no error (a pressing force required when the cell width is 27 mm in FIGS. 15 and 16).

As described above, when the plate-like separator presses the outer can 22, the dimensional error of the outer can 22 has a large influence. This is because the pressing force F significantly changes depending on the cell width of the outer can 22. On the other hand, according to the configuration of the separator 3 in the above embodiment, the pressing force F does not abruptly change. The influence of the dimensional error of the rectangular battery cell 2 to be laminated can therefore be reduced compared with the configuration in which the typical plate-like separator presses the outer can 22. Since variation of the load applied to the binding bar 6 can be reduced, rigidity of the binding bar 6 does not need to be increased more than necessary. The power supply apparatus 1 can also be downsized, for example, by reducing a thickness of the binding bar 6.

The battery block 4 is then formed by alternately laminating the rectangular battery cells 2 each having the rectangular parallelepiped outer can 22, and the separators 3 each having the pressing portions 32. The end plates 5 are provided at both ends of the battery block 4 in a direction of the lamination, and thereafter, the binding bars 6 are fixed to the end plates 5. Specifically, pressure is applied to the battery block 4 in the direction of the lamination with using a jig, and then, the binding bars 6 are screwed and fixed to the end plates 5. The battery block 4 having the binding bars 6 fixed thereto in such a manner is fastened by the binding bars 6 in a state of the pressure being applied in the direction of the lamination even if the jig is removed. The fastened battery block 4 is restrained in size and a fastening force changes depending on an expansion state of the rectangular battery cells 2 of the battery block 4.

The above power supply apparatus 1 can be used as a power supply for vehicles. Vehicles on which a power supply apparatus is mounted include electric vehicles such as hybrid automobiles or plug-in hybrid automobiles run and driven only by an engine and a motor, or electric automobiles run only by a motor. The power supply apparatus 1 is used as a power supply for these vehicles.

In addition to the power supply apparatus for vehicles, the power supply apparatus 1 can be appropriately used for various applications such as for a backup power supply apparatus mountable on a rack of a computer server, a backup power supply apparatus for a radio base station of a mobile phone or the like, a power supply for storage of electricity for household use or industrial use, a power supply for a street light or the like, an electrical storage apparatus in combination with a solar cell, and a backup power supply of a signal or the like.

### INDUSTRIAL APPLICABILITY

The present invention can be widely used for power supply apparatuses.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2011-237,006 filed in Japan on Oct. 28, 2011, the content of which is incorporated herein by reference.

What is claimed is:

1. A power supply apparatus comprising:
a plurality of battery cells each having a flat rectangular parallelepiped outer can, the battery cells provided so that wide surfaces of the outer cans are opposed to each other;
a separator provided between the battery cells; and
a fastener fastening the battery cells and the separator with the battery cells under application of pressure,
wherein the wide surface of the outer can comprises a circumference portion at a circumference of the wide surface and a central portion in a center of the wide surface, and
wherein the separator comprises an insulating portion insulating the adjacent battery cells and a pressing portion formed at a position corresponding to the central portion of the wide surface for pressing the central portion.

2. The power supply apparatus according to claim 1, wherein the outer can is a closed-end case for housing whose top surface is opened,
the battery cell comprises an electrode assembly provided in the outer can, a sealing body sealing an opening of the outer can, and output terminals fixed to the sealing body and electrically connected to the electrode assembly, and
the separator is provided so as to have space between the circumference portion in the vicinity of the sealing body and the insulating portion.

3. The power supply apparatus according to claim 2, wherein the insulating portion is provided so as to protrude upward over an end surface of the sealing body of the outer can.

4. The power supply apparatus according to claim 2, wherein the battery cell comprises a current blocking mechanism electrically blocking the output terminal and the electrode assembly when an internal pressure of the outer can increases, the current blocking mechanism provided in the vicinity of the sealing body.

5. The power supply apparatus according to claim 2, wherein the pressing portion comprises a peak portion in a center of the pressing portion and a circumference portion at a circumference of the peak portion, and
the pressing portion further comprises a first inclined plane formed from the peak portion to the circumference portion on un upper side and a second inclined plane formed from the peak portion to the circumference portion on a lower side.

6. The power supply apparatus according to claim 5, wherein the first inclined plane has a gentler gradient than does the second inclined plane.

7. The power supply apparatus according to claim 5, wherein the electrode assembly is formed by winding a laminate including a positive electrode and an negative electrode to obtain a wound body, the wound body provided in the outer can with an axial direction of the wound body parallel to the wide surface and oriented toward a horizontal direction of the outer can,
the pressing portion comprises a third inclined plane and a fourth inclined plane formed from the peak portion to the circumference portion provided on both sides, and
the pressing portion is further formed so that gradients of the third inclined plane and the fourth inclined plane become equal.

8. The power supply apparatus according to claim 5, wherein the current blocking mechanism is provided on one of the output terminals,
the pressing portion comprises a third inclined plane and a fourth inclined plane formed from the peak portion to the circumference portion provided on both sides,
the third inclined plane is formed in the vicinity of the current blocking mechanism, and
the pressing portion is further formed so that the third inclined plane has a steeper gradient than does the fourth inclined plane.
